(19) United States
(12) Patent Application Publication
(10) Pub. No.: US 2006/0128466 A1
(43) Pub. Date: Jun. 15, 2006

(54) Signalling

(75) Inventor: Martin Paul Moshal, Marina Bay (GI)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Waterleaf Limited

(21) Appl. No.: 10/532,037

(22) PCT Filed: Oct. 23, 2003
(86) PCT No.: PCT/IB03/04702

§ 371 Date: Oct. 14, 2005

(30) Foreign Application Priority Data
Oct. 25, 2002 (GB) 0224861.5

(51) Int. Cl. A63F 13/00

(52) U.S. Cl. 463/31

(57) ABSTRACT

A signalling system includes a gaming server operable under program control to regulate the progress of a multiplayer game in accordance with game play decisions made, in turn, by each of the participating players, a user terminal for each player, and a display monitor associated with each user terminal. Each user terminal is operable by a player to access the gaming server along a communication channel and to make game play decisions. Each display monitor is responsive to communication from the gaming server to display to a player an indicium, in the form of a graphic icon, representing a status of that player's participation in the game. The status is a pending state where that player is next in turn to make a game play decision, and a completed state where the player is not next in turn to make a game play decision. Each display monitor also displays a separate indicium for each participating player, each indicium representing a status of the participation in the game of a respective one of the participating players. Each graphic icon represents the status of a player's participation in the game by means of a colour, the pending state being represented by a red colour of the graphic icon, and the pending state being represented by a red colour of the graphic icon, and the completed state being represented by a green colour. Each graphic icon has a corresponding nameplate used for identifying a respective one of the participating players.

### FIELD OF THE INVENTION

This invention relates to a signalling system and, more particularly, to a signalling system that can be used in conjunction with a multiplayer online game. The invention extends to a signalling method for use in conjunction with a multiplayer online game.

### BACKGROUND TO THE INVENTION

The advent of online portals such as CompuServe, Prodigy, America Online (“AOL”) and the subsequent emergence of the Internet as a public communication channel have led to an explosion of on-line multiplayer games. A common feature of such games is that participants in such games are remote from each other and not in direct communication with each other. Each participant in the game monitors the progress of each turn of the game and the actions of the other participating players on a corresponding player terminal, usually incorporating a display screen.

One example of such an online multiplayer game is that of poker, which is nominally a zero-sum game insofar as, in each turn of the game, a gain of a winner is equal to accumulated losses of the other players in the game. It is, however, also known for a party who arranges or hosts a game of poker to levy a commission (“a rake”) on the cumulative amount wagered in the turn of the game, in order to obtain revenue.

A characteristic of such online multiplayer games is that a turn of the game usually involves one or more game-play decisions that must be taken by each player in turn. Where the participants in the game are remote from each other, it is possible that a particular player may inadvertently hold up progress of the turn of the game by failing to timeously take a required game play decision.

Such a circumstance may arise because a player may simply not be aware that he needs to make a game play decision, and that he is holding up progress of the game. It is a common feature of such online multiplayer games to have a watchdog feature that results in certain default game play decisions being taken on behalf of a player where that player holds up progress of the game for a time that exceeds a predetermined timeout period. It will be appreciated that this watchdog feature can adversely affect a player's performance in the online multiplayer game.

The problem is exacerbated in a game of poker, where game play decisions to be made by a player can be quite complex and require much consideration from the player

### OBJECT OF THE INVENTION

It is an object of this invention to provide a signalling system and a method of signalling that will, at least partially, alleviate the abovementioned difficulties and disadvantages.

### SUMMARY OF THE INVENTION

In accordance with this invention there is provided a signalling system, comprising:

a gaming server operable under program control to regulate progress of a multiplayer game playable by a plurality of participating players, in accordance with game play decisions made, in turn, by each of the participating players;

a user terminal associated with each player, each user terminal being operable by the player to access the gaming server along a communication channel and to make game play decisions; and

a display facility associated with each user terminal, the display facility being responsive to communication from the gaming server to display to the player an indicium representative of a status of that player's participation in the game, the status being a pending state where the player is next in turn to make a game play decision, and a completed state where the player is not next in turn to make a game play decision.

Further features of the invention provide for the display facility to be responsive to communication from the gaming server to display a plurality of indicia, each indicium being representative of a status of the participation in the game of a corresponding one of the plurality of the participating players, for the display facility to be a display monitor associated with the user terminal and for the indicium to be a graphic icon displayable on the display monitor, for the graphic icon to represent the status of the player's participation in the game by a colour, and for the pending state to be represented by a red colour and for the completed state to be represented by a green colour.

Still further features of the invention provide for each indicium to have a corresponding identification means for identifying a participating player whose participation status in the game is indicated by that indicium, and for the identification means to be a nameplate.

Yet further features of the invention provide for the multiplayer game to be a casino game, for the casino game to be an online casino game, and for the online casino game to be a game of poker.

The invention extends to a method of signalling, comprising the steps of:

regulating progress of a multiplayer game playable by a plurality of participating players, in accordance with game play decisions made, in turn, by each of the participating players;

accessing the gaming server from a user terminal, along a communication channel; and

displaying, on a display facility associated with the user terminal, an indicium representative of a status of a player's participation in the game, the status being a pending state where the player is next in turn to make a game play decision, and a completed state where the player is not next in turn to make a game play decision.

There is further provided for displaying on the display facility a plurality of indicia, each indicium being representative of a status of the participation in the game of a corresponding one of the plurality of participating players, for displaying any indicium as a graphic icon on a display monitor, for representing the status of the player's participation in the game by means of a colour of the graphic icon, and for representing the pending state by means of a red colour and for representing the completed state by means of a green colour.

There is still further provided for identifying the indicium of each player to uniquely identify that participating player, and for identifying the indicium by means of a corresponding nameplate.

### BRIEF DESCRIPTION OF THE DRAWINGS

One embodiment of the invention is described below, by way of example only, and with reference to the abovementioned drawings, in which:

FIG. 1 is a schematic representation of a signalling system, according to the invention;

FIG. 2 is a schematic representation of a Graphical User Interface of the signalling system of FIG. 1; and

FIG. 3 is an example of the Graphical User Interface of FIG. 2.

### DETAILED DESCRIPTION OF THE INVENTION

This embodiment of the invention will be described with particular reference to a system for playing a game of multiplayer poker. It is to be clearly understood, however, that the scope of the invention is not limited to this particular application.

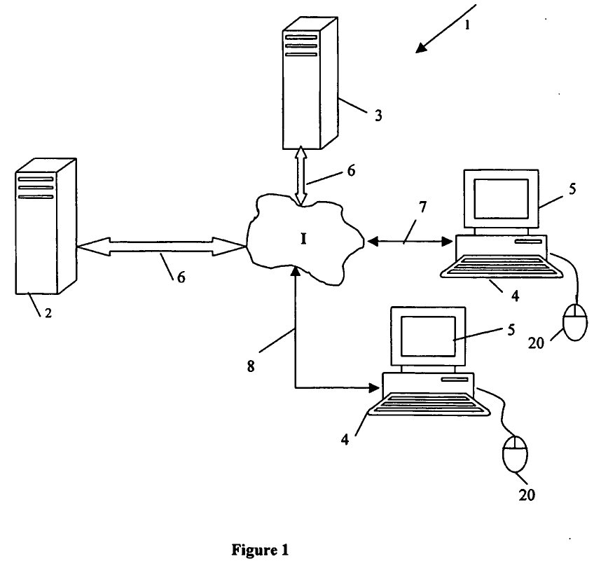

Referring to FIG. 1, a system for playing a game of online poker is indicated generally by reference numeral (1). The system (1) includes a gaming server (2), and a portal (not shown) in the form of an online casino website on the World Wide Web of the Internet. In this embodiment, the online casino website (not shown) is hosted on a casino web server (3). The casino website (not shown) is accessible by a plurality of poker players (not shown), each one through a separate user terminal (4) in the form of an Internet-enabled computer workstation having a display monitor (5) and an associated pointing device (20), such as a mouse or, alternatively, a touchpad. In this embodiment, casino website is shown as being accessible by players at two different computer workstations (4) logically connected thereto. It will be appreciated by those skilled in the art that such an on-line casino website can be logically connected to any desired number of such computer workstations (4) simultaneously, which number is physically limited only by considerations of processing power and Internet access bandwidth.

The gaming server (2), the online casino web server (3) hosting the online casino website, and the computer workstations (4) are capable of communicating with each other by means of an open communication channel that is, in this embodiment, the World Wide Web of the Internet. Although the World Wide Web of the Internet is a single packet-switched communication network, it is represented in FIG. 1, for convenience, as separate logical communication channels (6, 7 and 8).

The gaming server (2) operates under control of a stored program capable of enabling a predetermined maximum number, say 8 or 10, of players to play an instance of the game of online poker. When the number of players reaches this predetermined maximum number, the stored program causes a further instance of the game to be initiated, the new instance of the game also being capable of accommodating a further 8 or 10 players. In this manner the gaming server (2) is capable, under stored program control, to spawn as many separate instances of the game as required in order to accommodate a pool of players who desire to play the game, in groups of a maximum of 8.

Each instance of the game spawned in this manner is treated as totally independent of the other instances. For convenience, this specification will only discuss a single instance of the game.

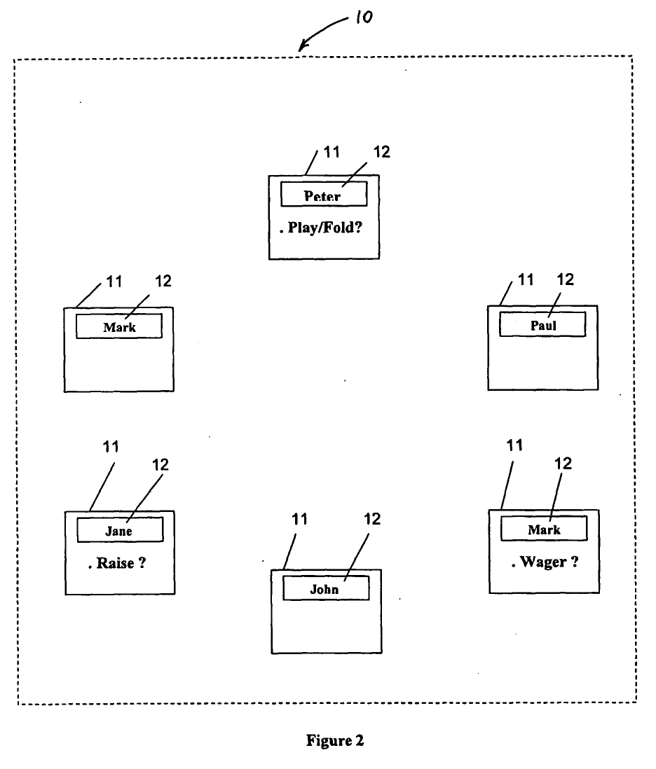

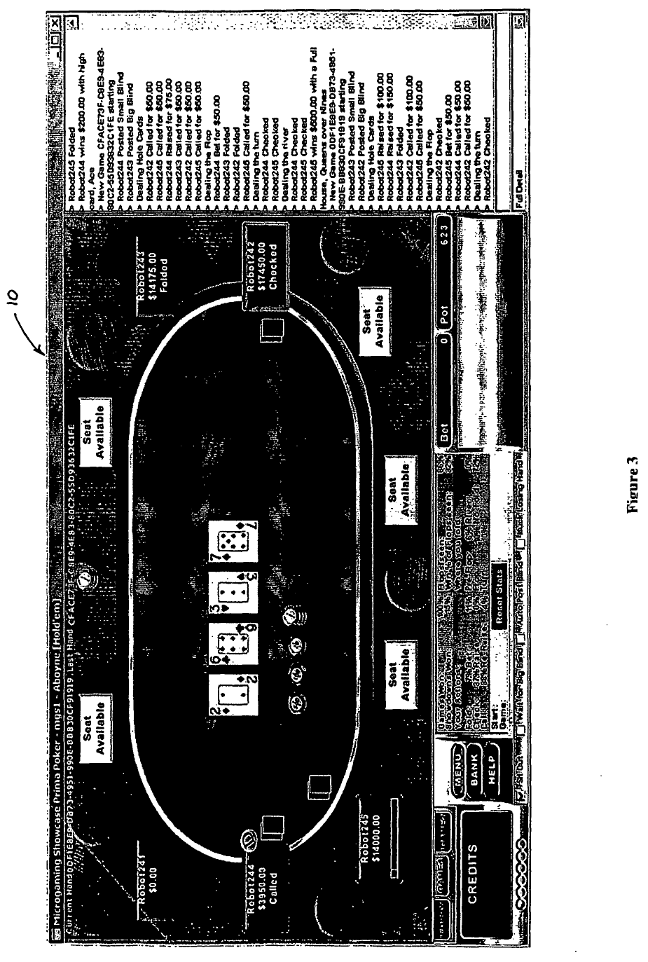

The online casino website enables a player desiring to join the game to request, by means of one of the computer workstations (4), participation in the game and, once admitted to an instance of the game, to place a wager on a turn of that instance of the game. Each participating player is presented with an identical graphical user interface (GUI) on his respective computer workstation (4) by the stored program in the gaming server (2). The GUI presents to the player a suitable display of a poker game (not shown) with appropriate icons that enable the player to make his own desired game play decisions and to monitor the progress of the game by viewing the game play decisions of the other participating players in the same instance of the game. The GUI includes a signalling system (10), as indicated in FIGS. 2 and 3, that is operable to alert the player when he, or any other player participating in the instance of the game, is due to make a game play decision.

In order to describe the operation of the signalling system (10), the rules of the game of multiplayer poker will now be described briefly. In a turn of the game, one of the players assumes the role of a dealer and deals five cards (an “initial hand”), from a conventional deck of 52 playing cards, to each participating player, inclusive of the dealer. The playing cards in the initial hand are dealt face down to each player who does not, at this stage of the game, disclose the playing cards that have been dealt to him.

Each one of the players is then required to decide, in turn, whether to continue with his participation in the turn of the game (that is, to “play”), or to terminate his participation in the turn (that is, to “fold”), as a function of the playing cards in his initial hand. Any player who decides to fold does not participate any longer in the turn of the game. The first player to decide to play is required to make an opening wager on the turn of the game. Any other player who subsequently also decides to play in the turn of the game is required to match or to increase (“raise”) the size of the opening wager. When the size of the opening wager is raised, players who have made or matched prior opening wagers are required to top up their wagers to match the size of the largest opening wager made by any player who has elected to play in the turn of the game. This phase of the turn of the game continues until every player who desires to play in that turn has wagered an equal amount.

All the wagers made by each of the players are accumulated in a single jackpot (“the pot”).

At this stage of the game, each player who has decided to play may, in turn, then decide to replace (that is, to “discard”) any one or more of the five cards in his initial hand. Once a player has decided which, if any, of the five cards to discard, the player may then “draw”, in which the discards of the initial hand are replaced by an equivalent number of further cards dealt by the dealer from the deck of playing cards. This phase of the game will be referred to, for convenience, as the drawing phase. If the player discards all of the cards in his initial hand, he is then effectively dealt an entirely new hand of five cards at the drawing phase. On the other hand, if a particular player retains (“holds”) all of the five cards in his initial hand, he does not participate in the drawing phase, but still continues to play in the turn of the game.

Once the drawing phase has been completed, each player evaluates the five cards that he has accumulated in the manner described above in order to determine whether they contain any one of a number of desirable combinations of playing cards. The desirability of any combination of playing cards is inversely proportional to the probability of being dealt that particular combination of cards. The various desirable combinations of playing cards are not relevant to the invention and will not be described here in detail.

After completion of the drawing phase of the turn of the game and evaluation of the playing cards, the players who have previously decided to play in the particular turn of the game are then again required to decide, in turn, as a function of the playing cards they have accumulated in the manner described above, whether to continue playing or to fold. Any player who decides to fold does not participate any further in the particular turn of the game and forfeits all the wagers he has made in that turn. The first player to make an opening wager, if he decides to play, may make a supplementary wager on the turn of the game. Any other player who subsequently also decides to play is required to match or to raise the size of the supplementary wager. Players who have previously made supplementary wagers are required to top up their supplementary wagers to match the size of the largest supplementary wager. This phase of the particular turn of the game continues until every player who had decided to continue playing has made an equivalent supplementary wager. This stage of the game will be referred to, for convenience, as the supplementary wagering stage.

The supplementary wagers made by each of the players who have decided to continue playing in the particular turn of the game are added to the pot.

Once the supplementary wagering stage of the turn of the game has been completed, the players who remain in the game reveal the playing cards in their hands. The hands are compared, and the player with the highest-ranking desirable hand wins the accumulated jackpot.

The rules of the game of poker have been described with particular reference to a variation of the game called “draw poker”. There are many other variations of the game of poker, the rules of which are not germane to the essence of the invention and that will not, for this reason, be described here in detail. The invention, however, also applies equally to these variations.

It will be appreciated by those skilled in the art that each participating player in the game is required to make a number of different game play decisions during each turn of the game. The possible game play decisions include a decision as to whether to play or to fold, a decision as to an appropriate size of an opening wager, a decision as to whether or not to raise a previous wager by another participating player, and an appropriate size of a raise wager. It will be further appreciated that, due to the sequential nature of the game, any player who delays in making a required game play decision will hold up the progress of the game. As the participating players are remote from each other and not in direct communication with each other, it is necessary to provide a mechanism to alert each one of the participating players of an outstanding game play decision and to allow them to follow the progress of the game.

The signalling system (10) consists of a plurality of indicia (11) in the form of icons displayed on the GUI of each player, a separate icon for each participating player in the instance of the game. Each icon (11) is in the shape of a rectangular outline and represents the status of the corresponding player's participation in the game. The status is represented by means of a colour of the rectangular outline. The status of the player's participation in the game is a pending state when the player has an outstanding game play decision to make, and a completed state where the player has no outstanding game play decision to make. The pending state is represented by a rectangular outline in red, while the completed state is displayed by a green rectangular outline.

Each icon (11) also displays information about the corresponding player's last game play decision in the turn of the game. In addition, each player's bankroll is displayed within the borders of the rectangular outline of that player's icon (11). Further, any particular player whose turn it is to make a game play decision is prompted to do so by means of a slider bar displayed within the borders of the rectangular outline of that player's icon (11). The slider bar display, which is well known in the art, and which will not be described here in detail, provides an indication to the player as to how much time remains within which to make the required game play decisions and avoid occurrence of a time out event. Information is displayed within the borders of the rectangular outline of the icon (11) as white text against a blue background. Each participating player is identified by a corresponding name (12) that can be the player's real name or a pseudonym selected by the player upon entering the instance of the game. The player's actual or assumed name is displayed within the borders of the rectangular outline of that player's icon (11).

Where the instance of the game is being played with one or more unoccupied playing positions, each such position is indicated on the GUI by appropriate black text against a white background, without a corresponding rectangular outline (11).

The GUI includes a scrollable window (not shown) in which a chronological log of each game event and each game play decision by the players in the current and previous turns of the game is displayed.

It will be appreciated by those skilled in the art that the system (1) provides a facility for pooling players from the casino website (not shown) to enable them to participate in the game of poker. Prior art systems which enable players to play multi-player games such as poker operate within the context of a single online casino and establish these games by utilising players from that casino only. This has undesirable consequences as the pool of potential players is limited to clients of that particular casino, and a considerable time may be required for a sufficient number of players to be gathered before a game can get underway, leading to player frustration and a high player attrition rate. The present invention can also establish a game with players drawn from a multiplicity of different online casinos, that is, from a larger pool of potential players, leading to the establishment of a poker game in a reduced time. Further, an established instance of a poker game according to the invention is likely to last longer than a game established under a prior art system, as there is a larger pool of available players from which replacements can be drawn to replace participating players who leave the instance of the game.

The technical problem solved by the invention is that of providing a means for efficient information exchange between players in a multiplayer online game. The signalling system encourages players to minimise delay, thereby ensuring that the multiplayer online game progresses without undue delay. Any participating player is able to see at a glance when there is an outstanding game play decision that he is required to make. The invention also assists participating players in the game to maintain an overview of game play decisions made by each of the players in any turn of the game.

Numerous modifications are possible to this invention without departing from the scope of the invention. In particular, the signalling system (10) may be applied to any multiplayer online game, whether requiring players to place wagers on the game, or not. Examples of such games are backgammon, bridge, gin rummy, canasta, whist or mah-jong. Further, a different form of icon (4) other than a rectangular outline may be used to provide notification to a player. Additionally, a different characteristic of the icon (4), other than colour, such as size or shape, can be used to indicate the pending and completed states of the player's participation in the turn of the game.

The invention therefore provides a novel system and method for inter-player signalling in an online multiplayer game.

1. A signalling system, comprising:
a gaming server operable under program control to regulate progress of a multiplayer game playable by a plurality of participating players, in accordance with game play decisions made, in turn, by each of the participating players;
a user terminal associated with each player, each user terminal being operable by the player to access the gaming server along a communication channel and to make game play decisions; and
a display facility associated with each user terminal, the display facility being responsive to communication from the gaming server to display to the player an indicium representative of a status of that player's participation in the game, the status being a pending state where the player is next in turn to make a game play decision, and a completed state where the player is not next in turn to make a game play decision.

2. A signalling system as claimed in claim 1 in which for the display facility is responsive to communication from the gaming server to display a plurality of indicia, each indicium being representative of a status of the participation in the game of a corresponding one of the plurality of the participating players.

3. A signalling system as claimed in claim 2 in which the display facility is a display monitor associated with the user terminal, and any indicium is a graphic icon displayable on the display monitor.

4. A signalling system as claimed in claim 3 in which the graphic icon represents the status of the player's participation in the game by a colour of the graphic icon.

5. A signalling system as claimed in claim 4 in which the pending state is represented by a red colour of the graphic icon, and the completed state is represented by a green colour of the graphic icon.

6. A signalling system as claimed in claim 5 in which each indicium has a corresponding identification means for identifying a participating player whose participation status in the game is indicated by that indicium.

7. A signalling system as claimed in claim 6 in which the identification means is a corresponding nameplate.

8. A signalling system as claimed in claim 1 in which the multiplayer game is a game of online poker.

9. A method of signalling, comprising the steps of:
regulating progress of a multiplayer game playable by a plurality of participating players, in accordance with game play decisions made, in turn, by each of the participating players;
accessing a gaming server from a user terminal, along a communication channel; and
displaying, on a display facility associated with the user terminal, an indicium representative of a status of a player's participation in the game, the status being a pending state where the player is next in turn to make a game play decision, and a completed state where the player is not next in turn to make a game play decision.

10. A method as claimed in claim 9 in which a plurality of indicia are displayed on the display facility, each indicium being representative of a status of the participation in the game of a corresponding one of the plurality of participating players.

11. A method as claimed in claim 10 in which any indicium is displayed as a graphic icon on a display monitor.

12. A method as claimed in claim 11 in which the status of the player's participation in the game is represented by means of a colour of the graphic icon.

13. A method as claimed in claim 12 in which the pending state is represented by means of a red colour of the graphic icon and the completed state is represented by means of a green colour of the graphic icon.

14. A method as claimed in claim 9 that includes the further step of identifying the indicium of each player to provide an identification of that participating player.

15. A method as claimed in claim 14 in which the indicium is identified by means of a corresponding nameplate.
